(19) United States
(12) Patent Application Publication
(10) Pub. No.: US 2017/0328872 A1
(43) Pub. Date: Nov. 16, 2017

(54) CHROMATOGRAPHIC SEPARATION DEVICE HAVING IMPROVED PEAK CAPACITY

(71) Applicant: Waters Technologies Corporation, Milford, MA (US)

(72) Inventors: Martin GILAR, Franklin, MA (US); Thomas MCDONALD, Littleton, MA (US)

(21) Appl. No.: 15/526,209

(22) PCT Filed: Oct. 30, 2015
(86) PCT No.: PCT/US15/58303

§ 371 Date: May 11, 2017

Related U.S. Application Data
(60) Provisional application No. 62/082,774, filed on Nov. 21, 2014.

(51) Int. Cl. G01N 30/46; G01N 30/52

(52) U.S. Cl. CPC G01N 30/461; G01N 30/52

(57) ABSTRACT

Described are a chromatographic separation device and a method for performing a chromatographic separation. The device two chromatographic separation modules in serial communication. The first module is adapted to receive a gradient includes mobile phase. The second module receives the gradient mobile phase that exits from the first module. The first and second modules include chromatographic sorbents that differ in one or more of composition, particle size and sorbent temperature. The retentivity of the second module is greater than the retentivity of the first module and the chromatographic dispersion of the second module is less than the chromatographic dispersion of the first module. The width of a chromatographic peak eluted from the first module is greater than a width of the same chromatographic peak after elution from the second module. The device has a high peak capacity without the need to pack a full column length with small sorbent particles.

### FIELD OF THE INVENTION

The invention relates generally to gradient mobile phase liquid chromatography. More particularly, the invention relates to a method and a device for enhancing the peak capacity of a liquid chromatography system.

### BACKGROUND

In liquid chromatography, a sample containing a number of components to be separated is injected into a system flow and directed through a chromatographic column. The column separates the mixture by differential retention into its individual components. The components elute from the column as distinct bands separated in time.

A typical liquid chromatography system includes a pump for delivering a fluid (the “mobile phase”) at a controlled flow rate and composition, an injector to introduce a sample solution into the flowing mobile phase, a chromatographic column that contains a packing material or sorbent (the “stationary phase”), and a detector to detect the presence and amount of the sample components in the mobile phase leaving the column. When the mobile phase passes through the stationary phase, each component of the sample typically emerges from the column at a different time because different components in the sample typically have different affinities for the packing material. The presence of a particular component in the mobile phase exiting the column can be detected by measuring changes in a physical or chemical property of the eluent. By plotting the detector signal as a function of time, response “peaks” corresponding to the presence and quantities of the components of the sample can be observed.

Small quantities of a component exiting the column can be difficult to detect, especially if the width of the peak is significant relative to the amplitude of the peak. Moreover, peaks that occur closely in time can be difficult to detect, especially when there is no baseline separation between the peaks.

### SUMMARY

In one aspect, a chromatographic separation device includes a first chromatographic separation module and a second chromatographic separation module. The first chromatographic separation module comprises a first chromatographic sorbent having a first retentivity, a first length and a first chromatographic dispersion. The second chromatographic separation module is configured in serial communication with the first chromatographic separation module to receive a gradient mobile phase. The second chromatographic separation module comprises a chromatographic sorbent having a second retentivity that is greater than the first retentivity, a second length that is shorter than the first length, and a second chromatographic dispersion that is less than the first chromatographic dispersion. A width of a chromatographic peak in the gradient mobile phase eluted from the first chromatographic separation module is greater than the width of the chromatographic peak in the gradient mobile phase eluted from the second chromatographic separation module

In another aspect, a method for performing a chromatographic separation includes providing a flow of a gradient mobile phase through a first chromatographic separation module having a first retentivity, a first length and a first chromatographic dispersion. The method also includes providing a flow of the gradient mobile phase eluted from the first chromatographic separation module to a second chromatographic separation module having a second retentivity that is greater than the first retentivity, a second length that is shorter than the first length, and a second chromatographic dispersion that is less than the first chromatographic dispersion. A width of a chromatographic peak in the gradient mobile phase eluted from the first chromatographic separation module is greater than a width of the chromatographic peak in the gradient mobile phase eluted from the second chromatographic separation module.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is a functional block diagram of an embodiment of a chromatographic separation device with improved peak capacity.

FIG. 2 is a functional block diagram of another embodiment of a chromatographic separation device with improved peak capacity.

FIG. 3 is a functional block diagram of an embodiment of a chromatographic separation device that includes a temperature controller to maintain the first and second chromatographic separation modules at different temperatures.

FIG. 4 is a functional block diagram showing an embodiment of a chromatographic separation device in which a mobile phase is introduced into the gradient mobile phase flowing between the first and second chromatographic separation modules.

FIG. 5 is a bar graph display of measurement results for peak widths determined for two different peptides using various embodiments of chromatographic separation devices according to the invention.

FIG. 6 shows a chromatogram obtained using a single chromatographic column and a chromatogram obtained using a chromatographic separation device according to an embodiment of the invention.

FIG. 7 is a bar graph display of measurement results for peak widths determined for naringine and naproxen using various embodiments of chromatographic separation devices according to the invention.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The goal of chromatography is to separate different compounds from one another and elute them from chromatographic device in narrow peaks or “zones.” This is often accomplished using a gradient mobile phase in which the composition of the mobile phase changes with time. Two opposing effects are present for an injected zone in a gradient mobile phase. One effect is dispersion which causes the width of the zone traveling through a column to increase due to the inhomogeneity of the packed bed, molecular diffusion, and mass transfer resistance in the interacting mobile and stationary phases. The result is peak broadening which is more pronounced in long columns packed with large sorbent particles. The opposing effect is zone focusing, or peak compression, which occurs as a result of the gradient elution process. The peak compression effect is typically minor, especially for small molecules. Compression is generally not utilized to reduce peak widths, with the exception of step gradients in which a sample is focused on a head of a column using a weak mobile phase in conventional, capillary or nano-scale liquid chromatography, or for peak focusing in a second dimension column during two-dimensional gas chromatography or liquid chromatography.

An analyte zone has a physical width on the chromatographic column. Consequently, the sample molecules in the later (“rear”) portion of the zone are exposed to a slightly stronger solvent for elution then the sample molecules in the earlier (“front”) portion of the zone. As a result, the sample molecules in the rear portion are less retained than those in the front portion. The difference in the mobile phase composition between the front and rear portions is typically small. For example, the composition difference can be less than 0.01% to more than 1%. This small difference results in a peak compression of approximately 8% for small molecules (e.g., molecular weight less than 500 g/mol or 1,000 g/mol). In contrast, approximately 10% to 30% peak width compression should be achievable for peptides and large biopolymers such as proteins and nucleic acids.

If the physical limitation of column dispersion is eliminated, the width of each zone would reduce to zero; however, dispersion is always present and the peaks have finite widths determined, in part, by sorbent particle size and the gradient slope.

In brief overview, the invention relates to a chromatographic separation device and a method for performing a chromatographic separation. The chromatographic separation device includes two chromatographic separation modules configured in serial communication. The first chromatographic separation module is adapted to receive a gradient mobile phase that includes a sample for separation. The second chromatographic separation module receives the gradient mobile phase that exits from the first chromatographic separation module. The first and second chromatographic separation modules include chromatographic sorbents that differ in one or more of composition, particle size and sorbent temperature. The retentivity of the second chromatographic separation module is greater than the retentivity of the first chromatographic separation module and the chromatographic dispersion of the second chromatographic separation module is less than the chromatographic dispersion of the first chromatographic separation module. A width of a chromatographic peak in the gradient mobile phase eluted from the first chromatographic separation module is greater than a width of the same chromatographic peak after elution from the second chromatographic separation module. Thus the peak capacity of the chromatographic separation device is greater than the peak capacity of the first chromatographic separation module.

Advantageously, the device achieves improved chromatographic resolution in liquid chromatography systems and microfluidic liquid chromatography systems. For well focusing molecules such as peptides and biopolymers of large molecular weight, the device has high peak capacity without the need to pack a full column length with small sorbent particles. Thus the device can operate at lower pressure and with reduced frictional heating compared to conventional chromatographic columns and ultra performance liquid chromatography (UPLC®) columns.

The present teaching will now be described in more detail with reference to embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

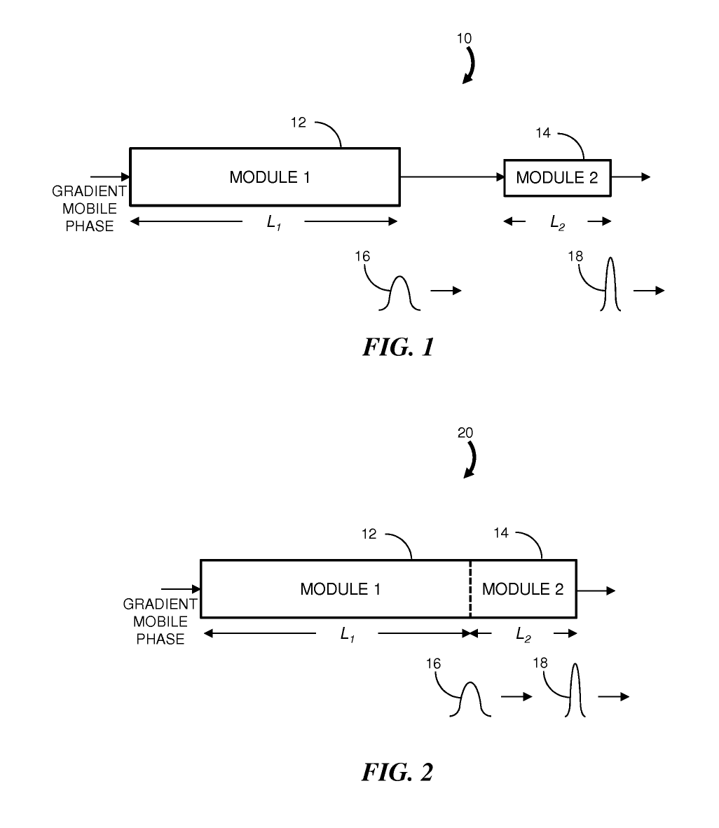

FIG. 1 is a functional block diagram of an embodiment of a chromatographic separation device 10 that has improved peak capacity relative to conventional chromatographic columns. The device 10 includes a first chromatographic separation module 12 and second chromatographic separation module 14 in serial communication such that a mobile phase flows through the first separation module 12 and then through the second separation module 14. An analyte zone (or peak) 16 is eluted from the first separation module 12 at a retention time according to the particular analyte and the retentivity of the first separation module 12. The width of the peak 16 is determined in part by the chromatographic dispersion of the first separation module 12. Subsequently, the eluted zone within the mobile phase passes through the second separation module 14 which has a higher retentivity than the first separation module 12. Consequently, the eluted zone 16 is re-focused at the second separation module 14. For example, the second separation module 14 can include a substantially more retentive sorbent than the sorbent present in the first separation module 12.

If both separation modules 12 and 14 include sorbents having the same particle size, the same dispersion results and no substantial peak focusing occurs. In contrast, if the second separation module 14 is packed with a sorbent formed of smaller particles than the particles in the first separation module 12, band compression is achieved and a narrow peak is eluted. The peak width of the analyte zone eluted from the second separation module 14 is determined by the smaller particle size. Further, the length L₂ of the second separation module 14 can be short, while a first separation module 12 of greater length L₁ and having the larger sorbent particles determines the separation selectivity and resolution. When focusing is efficient, peak widths can be achieved that are similar to that of a single separation module having smaller sorbent particles with a combined lengths L₁+L₂ of the two modules 12 and 14. The smaller length L₂ of the second separation module 14 avoids the use of a higher pressure which would be otherwise required if both separation modules 12 and 14 were formed with the sorbent having the smaller particle size.

As illustrated in FIG. 1, the two chromatographic separation modules 12 and 14 are distinct, that is, they can be two separate chromatographic columns in fluidic serial communication through couplings and tubing. The column internal diameters do not have to be the same. For example, it is sometimes beneficial for the internal diameter of the column corresponding to the second chromatographic module 14 to be smaller to achieve an optimal linear velocity for the flow. Alternatively, the two chromatographic separation modules 12 and 14 can be provided as an integrated chromatographic separation column 20 as shown in FIG. 2. For example, one portion of the column 20 corresponding to the first separation module 12 can be packed with a sorbent having larger particles and lesser retentivity while the other portion corresponding to the second separation module 14 can be packed with a sorbent having smaller particles and greater retentivity.

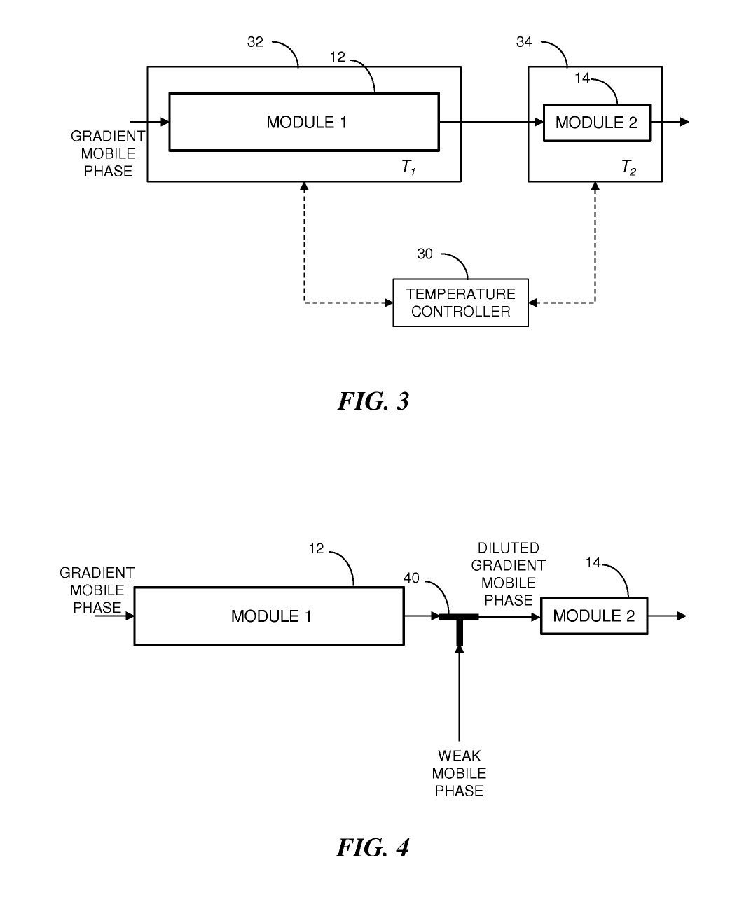

Differential temperature control of the chromatographic separation modules 12 and 14 can be used to achieve a difference in retentivity of the two separation modules 12 and 14. This differential temperature control can be used as the sole means to achieve differential retentivity. FIG. 3 illustrates an embodiment in which a temperature controller 30 is used to maintain a thermal environment 32 of the first separation module 12 at a temperature T₁ and to maintain a thermal environment 34 of the second separation module 14 at a different temperature T₂. This method of controlling retentivity according to temperature can be used in combination with the use of different sorbents to achieve a greater difference in retentivities for improved peak capacity. In some cases, one can achieve an increase in retentivity by increasing the column temperature. This is achieved with collapsible stationary phases, their hydrophobic ligand unfolds at higher temperature making the column more retentive.

In an alternative embodiment as shown in FIG. 4, a mobile phase is introduced into the gradient mobile phase flowing from the first chromatographic separation module 12 to the second chromatographic separation module 14, for example, at a tee fitting 40. As a result, the retentivity of the second separation module 14 is effectively reduced relative to the retentivity for an undiluted flow of the gradient mobile phase; however, the mobile phase dilution process dilutes peaks and increases their volume in terms of peak width, thereby partially counteracting the focusing process. The use of a separate mobile phase to dilute the gradient mobile phase can be combined with the use of different sorbents and/or the use of temperature controlled retentivity, as described above, to improve peak capacity.

### Evaluation

An evaluation of techniques described above was performed using a 100 mm long, 2.1 mm diameter XBridge™ C8 5 μm column (available from Waters Corporation of Milford, Mass.) for the first chromatographic separation module and a 30 mm long, 2.1 diameter column packed with a more retentive HSS T3 1.8 μm sorbent for the second chromatographic separation module. A mobile phase gradient of 10% acetonitrile per minute was used and the peak widths at 13.4% of peak height were determined.

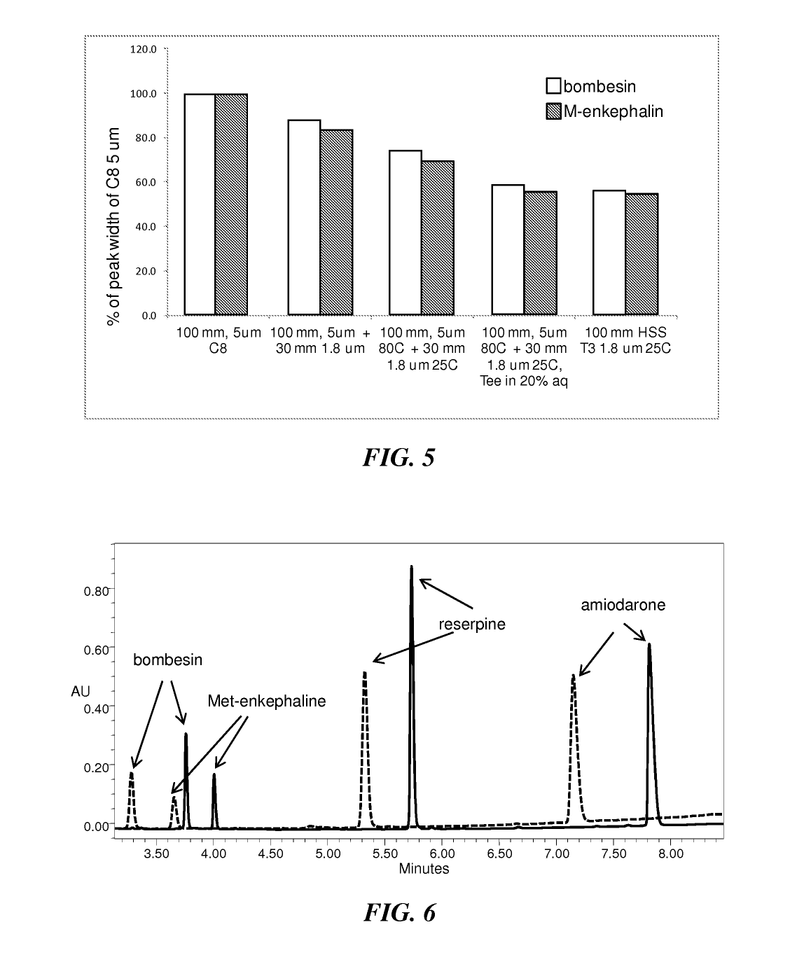

The bar graph display of FIG. 5 shows the chromatogram peak width for two different peptides, bombesin (MW 1619.8) and Met-enkephaline (MW 573.7 Da), for a variety of chromatographic separation techniques. For all data, the mobile phase composition was A: 0.12% trifluoroacetic acid (TFA) in water and B: 0.1% TFA in acetonitrile. The flow rate was 0.3 ml/min and the gradient started at 0% B and changed at 10% acetonitrile/min. The peak widths are indicated by the vertical extent of the bars. The peak width values are normalized to the peak widths obtained by using only the XBridge C8 column, as shown for the first pair of bars. The third and fourth pairs of bars shows results with a first additional condition of maintaining the XBridge C8 column at 80° C. and the HSS T3 1.8 μm column at 25° C. The fourth set of bars had a second additional condition of introducing a 20% volume of aqueous mobile phase between the two columns to dilute the gradient mobile phase before it enters the HSS T3 1.8 μm column. For comparison, the fifth set of bars show the results obtained for the two peptides using only a single 100 mm long, 2.1 diameter HSS T3 1.8 μm column.

FIG. 6 shows two different chromatograms. The first chromatogram is shown by the dashed line and corresponds to use of a single 100 mm length XBridge C8 5 μm column at 25° C. The second chromatogram is shown by the solid line. The second chromatogram was based on use of the 100 mm XBridge C8 5 μm column at a higher temperature of 80° C. and a second attached 30 mm HSS T3 (C18) column packed with 1.8 um sorbent and maintained at 25° C. A 20% of volume mobile phase was introduced into the gradient mobile phase before the second column. The widths of the bombesin and Met-enkephaline peaks correspond to the values shown in the fourth set of bars in FIG. 5. As expected, the peaks of the second chromatogram are substantially greater in amplitude and narrower in width than the corresponding peaks in the first chromatogram.

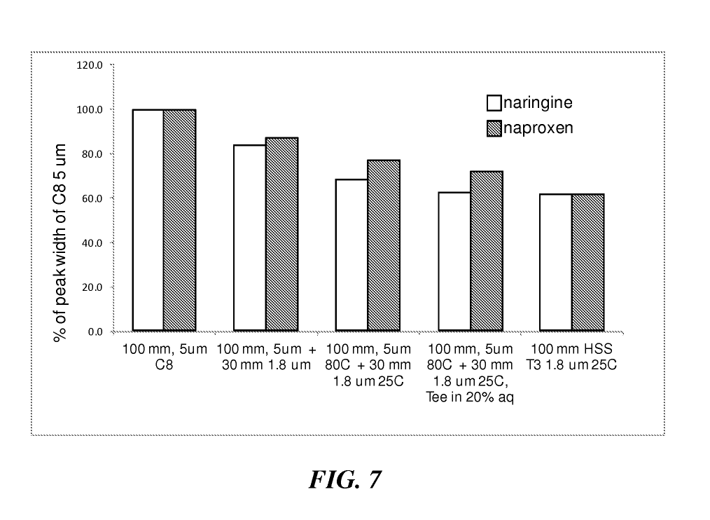

FIG. 7 shows the test results obtained for naringine and naproxen. The chromatographic conditions are the same as those described above for FIG. 5 and the results are normalized to the peak widths obtained using only the 100 mm long, 2.1 mm diameter XBridge™ C8 5 μm column. Again, the fifth set of bars show the data obtained using only a single 100 mm long, 2.1 diameter HSS T3 1.8 μm column for comparison.

A comparison of FIG. 5 and FIG. 6 indicates that large molecules, such as the peptides of FIG. 5, focus more effectively than small molecules, such as naproxen. FIG. 6 shows that the moderate size molecule naringine (MW 580.5 Da) focuses better than small molecular size naproxen (MW 230.3 Da).

The evaluation measurement data confirm that peak capacity can be improved by using a chromatographic column having a larger particle size sorbent coupled to a shorter and more retentive chromatographic column packed with smaller particle size sorbent.

Configurations different from those described above for the evaluations can be used. For example, the first column can be packed with a sorbent having a particle size in a range of approximately 5 μm to approximately 10 μm and the second, shorter column packed with a substantially smaller sorbent that, for example, may have a particle size that is less than 0.5 μm to 1.8 μm or more. With a particle size of approximately 0.5 μm to approximately 1.5 μm for the second column, the total system pressure is within the operating range of current liquid chromatography pumps. The resulting peak capacity can be as large as a longer column packed with 0.5 μm to 1.5 μm particle size sorbent which would not be suitable for current liquid chromatography systems due to requirement for a much higher system pressure.

The evaluation results demonstrate that a temperature step gradient, achieved by maintaining different column temperatures, can be used independently or in combination with columns of different sized sorbent particles. Similarly, mobile phase dilution between the two columns can be used independently, or in combination with one or both of these two techniques.

The various embodiments described above can be adapted for use in microfluidic liquid chromatography systems. For example, the turns in a microfluidic chromatographic column can generate excessive band broadening. Implementing the embodiments described above for a microfluidic structure allows for improved performance by achieving peak compression prior to band elution. Embodiments described above can also be used to compress wide zones created by injection of large sample volumes.

While the invention has been shown and described with reference to specific embodiments, it should be understood by those skilled in the art that various changes in form and detail may be made therein without departing from the spirit and scope of the invention as recited in the accompanying claims.

1. A chromatographic separation device comprising:
a first chromatographic separation module comprising a first chromatographic sorbent having a first retentivity, a first length and a first chromatographic dispersion;
a second chromatographic separation module configured in serial communication with the first chromatographic separation module to receive a gradient mobile phase therefrom, the second chromatographic separation module comprising a chromatographic sorbent having a second retentivity that is greater than the first retentivity, a second length that is shorter than the first length, and a second chromatographic dispersion that is less than the first chromatographic dispersion, wherein a width of a chromatographic peak in the gradient mobile phase eluted from the first chromatographic separation module is greater than the width of the chromatographic peak in the gradient mobile phase eluted from the second chromatographic separation module.

2. The device of claim 1 wherein a sorbent particle size of the first chromatographic separation module is greater than a sorbent particle size of the second chromatographic separation module.

3. The device of claim 1 wherein the first chromatographic separation module and the second chromatographic separation module comprise a pair of chromatographic columns in serial communication.

4. The device of claim 1 wherein the first and second chromatographic separation modules are formed in a single chromatographic column.

5. The device of claim 4 wherein the single chromatographic column is packed with sorbent having a particle size that changes as a gradient along a length of the single chromatographic column.

6. The device of claim 5 wherein the sorbent has a retentivity gradient along the length of the single chromatographic column.

7. The device of claim 1 wherein at least one of the first and second chromatographic separation modules is a monolithic sorbent.

8. The device of claim 1 further comprising a temperature controller in communication with the first and second chromatographic separation modules and configured to maintain a temperature differential therebetween.

9. A method for performing a chromatographic separation, the method comprising:
providing a flow of a gradient mobile phase through a first chromatographic separation module having a first retentivity, a first length and a first chromatographic dispersion; and
providing a flow of the gradient mobile phase eluted from the first chromatographic separation module to a second chromatographic separation module having a second retentivity that is greater than the first retentivity, a second length that is shorter than the first length, and a second chromatographic dispersion that is less than the first chromatographic dispersion, wherein a width of a chromatographic peak in the gradient mobile phase eluted from the first chromatographic separation module is greater than a width of the chromatographic peak in the gradient mobile phase eluted from the second chromatographic separation module.

10. The method of claim 9 wherein a temperature of the first chromatographic separation module is different from a temperature of the second chromatographic separation module.

11. The method of claim 9 wherein providing the flow of the gradient mobile phase eluted from the first chromatographic separation module to the second chromatographic separation module comprises providing a diluted flow of the gradient mobile phase eluted from the first chromatographic separation module to the second chromatographic separation module.

12. The method of claim 11 wherein a diluent used to dilute the flow of the gradient mobile phase is a weak mobile phase.

13. The method of claim 12 wherein the weak mobile phase is an aqueous solvent.

14. The device of claim 1 wherein at least one of the first chromatographic separation module and the second chromatographic separation module is disposed in a microfluidic liquid chromatography system.

15. The device of claim 4 wherein the single chromatographic column is disposed in a microfluidic liquid chromatography system.

16. The method of claim 9 wherein at least one of the first chromatographic separation module and the second chromatographic separation module is disposed in a microfluidic chromatography system.
